(19) United States
(12) Patent Application Publication
(10) Pub. No.: US 2024/0251990 A1
(43) Pub. Date: Aug. 1, 2024

(54) FOLDABLE GRID AND STORE BOX

(71) Applicant: GR8 ID BV, Gent (BE)

(72) Inventor: Tom CEULEMANS, Sint-Amandsberg (BE)

(21) Appl. No.: 18/560,497

(22) PCT Filed: May 14, 2021
(86) PCT No.: PCT/EP2021/062886

§ 371 Date: Nov. 13, 2023

(51) Int. Cl. A47J 37/06; A47J 37/07

(52) U.S. Cl. CPC A47J 37/0694; A47J 2037/0777

(57) ABSTRACT

The invention relates to an improved grill grid, preferably for barbecues. The improved grill allows for a more compact form, which facilitates cleaning, storage and handling, as well as ensuring its functionality on many types and especially sizes of barbecue sets.

### FIELD OF INVENTION

The invention is directed to grids used with barbecues and other kinds of cookers to support food above a heat source in combination with a storage box. The store box contains cleaning means to clean the grid after use.

### BACKGROUND OF INVENTION

Grills, like barbeque grills, have grids used to support food above a source of heat, such as burning charcoal or a gas burner. The grids have a plurality of laterally spaced rods secured to a continuous circular or rectangular rim. Handles on outer sections of the grids facilitate handling of the grids for cleaning and storage. To store the grid more efficiently, the grid can be folded or divided into different parts. An example of a foldable cooker is shown in U.S. Pat. No. 4,432,334 (A). This grid assembly has first and second grid mean pivotally connected to each other with a hinge means. The first and second grid sections to align with others when they are in the open position.

The conventional grids have diameters of between 40 and 50 or more or less cm. The size of these grids prohibits cleaning of the grids in a self-cleaning oven or dishwasher. The entire grid is removed from the kettle to provide access to the grate and allow convenient removal of the ashes from the kettle. The grid in use collects carbon, ash, and food particles. Scraping tools, brushes, washcloths, and cleaners are used to clean the grid.

### SUMMARY OF INVENTION

The invention is a grid or grid assembly for use with a barbeque grid. The goal of the invention is to downsize the size of the grid so it can be stored in a smaller box. To achieve this goal, the grid can be folded or disassembled into different smaller pieces.

According to the first method, the grid assembly is an articulated grid structure having an open position and a folded position. The grid assembly has multiple grids sections pivotally connected with a hinge means or grid hinge. These grid sections are in alignment with others when they are in the open position. The open grid assembly fits on the barbecue and is retained therein above the grate and heat source. The grid assembly is manually removed from the kettle and can be pivoted to a folded position.

According to the second method, the grid assembly is an articulated grid structure having an assembled and disassembled configuration. The grid assembly has multiple grids means connected to each other using click techniques. These grid sections are in alignment with others when they are in the assembled position. The assembled grid assembly fits on the barbecue and is retained therein above the grate and heat source. The grid assembly is manually removed from the barbecue and can be disassembled to reduce the size of the grid.

The grid assembly can be reduced in size to fit into a box whereby the cleaning product cleans the grid assembly optionally using extra heat. When the folded grid assembly is placed in the box, the higher temperature efficiently cleans the grid assembly, especially in combination with enzymes with maximum efficiency at a specific temperature during a certain time. Other cleaning products are also possible, whether or not on an alkaline basis

### DESCRIPTION

The preferred embodiments of the grid assembly of the invention have a pair of grid sections with grid rods 30 for supporting the food.

The grid rods 30 may have linear, semi-circular, square, rectangular, semi-oval, and like cross-sections.

The grid assembly itself may have a rectangular, square, oval, circular, semi-circular, semi-oval and similar surface when unfolded.

The grid assembly can also be provided with at least one handle. In one possible embodiment, this handle is detachable and can even be combined with gripping pliers. In the function of gripping tongs, the gripping tongs can also be used to grab the meat around other items on the barbecue. In another possible embodiment, the handle can be hinged. This is done in such a way that the grille is also adjustable in height.

In another possible embodiment, the handles are fixedly connected. This could be directly on the grid itself or on the locking mechanism that connects and blocks the different parts of the grid.

It is also possible that the grid is provided with mounting pins. These pins are mounted on the side of the grill itself, on the blocking device and/or other parts communicating with the grill.

The mounting pins can be removable, adjustable in height, suitable for recessed application, and even constructed from several parts.

The grid itself can be provided with several layers. Thus, a device can be provided in which a second or more grid layers can be provided, which may or may not be removable. In some cases, it is also foldable. It is also possible here that even several grid layers are provided one above the other. These are interconnected by connecting pieces that may or may not be demountable.

The purpose of dividing the grid into smaller segments is to fit the grid into a smaller box than the composite grid. The goal is to store the grid in a box after use. A cleaning agent can be applied in this box. This cleaning agent is preferably biodegradable like enzymes. These enzymes, as it were, eat up the remaining biological waste that is still hanging on the grid. This will give you a clean schedule again.

For the enzymes to work optimally, a temperature between 30 and 60 degrees Celsius is required, a temperature between 40 and 60 degrees Celsius is ideal. To achieve this, the box can be equipped with a heating element. Most enzymes come in powder form. This powder has the property to remain in place, and in most cases, it is necessary to mix it mechanically with the water. This can be done manually, but preferably a mixer is used that is electrically driven.

To make the fact that a grid is stored in a box commercially feasible, it is advisable to drastically reduce the size of the grid. For this, the roster is reduced by at least a factor of 2. This can be done by using techniques in which the different parts of the grid are folded up or separated from each other.

When assembling the different parts of the grill, they must be firmly anchored to each other.

In a first aspect of the invention, the grid assembly comprises multiple grid sections, which are provided in a foldable manner:

These can be provided with so-called protruding supports, which mutually support the various parts.

The hinge means pivotally connecting the pair of grid means includes a hinge bar and loop mean located around the hinge bar. The loop means can have different designs. One possible embodiment is that the loop means are twisted ends of some of the grid bars. Another possible embodiment is that the looping means consists of grid bars that are formed in an o-shape. This connects the different grid bars of the different parts so that they can make a pivoting movement and thus fold together with respect to each other.

They can be provided with a support device that commonly supports the different parts and preferably also clamps them. This can be done so that it is removable and can be considered a separate part.

These can be provided with support that commonly supports the different parts. This can be done so that it is not removable and can be regarded as part of the composition. One possible embodiment is in which the central support is arranged rotatably. This rotatable support supports the various parts during the unscrewing. In this position, this support can also be blocked by a locking device.

In the second aspect of the invention, the different grid sections can be regarded as separate parts.

These can be provided with so-called protruding supports, which mutually support the various parts.

These can be provided with support that commonly supports the different parts. This can be done so that it is removable and can be considered a separate part.

These can be provided with support that commonly supports the different parts and preferably also clamps them. This can be done so that it is not removable and can be regarded as part of one of the grid parts, which is then preferably arranged centrally. One possible embodiment is in which the central support is arranged rotatably. This pivotable support supports the different parts when turning them out. In this position, this support can also be blocked by a locking device.

Another possible embodiment is that the various partial grids are designed to be rolled up relative to each other.

A possible extension to the foregoing embodiments is that the handle is constructed in such a way that it can also be set to different positions. This allows the grid to be positioned higher or lower than the outer shape of the barbecue and in different positions.

The entire grid assembly is coated with a rust-resistant, heat-resistant and non-toxic material, such as a nickel-chrome alloy. Other non-toxic materials can be used to protect the grid composition from heat and chemical reactions, such as rusting.

In a first aspect, the invention relates to a foldable grill grid, preferably for a barbecue, subdivided in substantially planar, subsequent grid sections. The grid comprises at least a first grid section, a second grid section and one or more central grid sections positioned between the first and the second grid section. The central grid sections comprise two opposite and parallel hinge sides, and the first and the second grid section each comprise one hinge side, parallel to and adjoining the hinge side of an adjacent central grid section.

The grid sections comprise a plurality of parallel and preferably mutually equidistant grid rods, which are interconnected by one or more support rods, wherein the support rods are positioned at the same side of the unfolded grid.

The first grid section is hingedly connected with one hinge side to one of the hinge sides of one of the central grid sections, wherein the second grid section is hingedly connected with one hinge side to one of the hinge sides of one of the central grid sections, and wherein each central grid section is hingedly connected with each of its hinge sides to a hinge side of at least one of the grid sections.

The grid rods of the central grid sections are parallel with the hinge sides of the central grid sections, and wherein the grid rods of the first and second grid sections are parallel with the hinge side of the first and second grid sections.

At least one of the first grid section or the adjoining central grid section comprises at least one, preferably at least two, alignment elements, which extends beyond the at least one grid section and parallel thereto past the hinge side of the at least one grid section adjoining the hinge side of the other grid section, thereby limiting the hinging of the two adjoining grid sections to an angle of about 180° in at least one direction of rotation.

At least one of the second grid section or the adjoining central grid section comprise at least one, preferably at least two, alignment elements, which extends beyond the at least one grid section and parallel thereto past the hinge side of the at least one grid section adjoining the hinge side of the other grid section, thereby limiting the hinging of the two adjoining grid sections to an angle of about 180° in at least one direction of rotation.

It should be noted that in an alternative embodiment, the grid rods can be perpendicular to the hinge sides.

Additionally, in some embodiments, alignment means are also provided between central grid sections as above between a central grid section and the first or second grid section.

The above embodiment allows for a fast and easy unfolding of the grill assembly, and allows a very compact folding thereof.

Preferably, the grid comprises a rotatable support section or central pivoting supporting means, extending over a length at least higher than the distance between the first and second section when the grid is unfolded, said support section or central pivoting supporting means being attached to a central grid section to allow rotation around a rotation axis perpendicular to the plane of said central grid section, and having a width lower than the width of the central grid section to which it is rotatably attached. The rotatable section/pivoting means can be provided via a swivel joint connecting said section/means to a grid section.

In a further preferred embodiment, at least one of the grid sections comprises a blocking means at a position on an axis perpendicular to the hinge side of the grid section and parallel to the unfolded grid, and said axis intersecting the rotation axis when the grid is unfolded, said blocking means being configured to limit rotation of the support section/central pivoting supporting means to an angle of about 90° with respect to the hinge sides of the grid sections, said blocking means preferably being hook-shaped, with a distal end extending parallel to the grid rods.

In a preferred embodiment, the alignment elements are part of or extend from the support rods. By extending the support rods beyond the surface of the grid sections to which they are attached, they can effectively block rotation of the subsequent grid sections beyond 180°, allowing the grid to unfold to a horizontal position, but not beyond that. Note that further supporting elements can be provided, such as the central pivoting supporting means. It is to be understood that the alignment elements extend past the hinge sides of the grid section to an extent that they extend beyond at least the closest, but preferably also the second closest (or even third, etc.) grid rod of the adjoining grid section, to ensure that the grid sections are held at an angle of 180° (unfolded).

In a possible embodiment, the hinge side of a first of two adjoining grid sections comprises a grid rod, and the hinge side of the second of the two subsequent grid sections comprises at least two grid hinges which are hingedly connected to the hinge side of the first of the two subsequent grid sections.

In a preferred embodiment, the adjoining grid sections are hingedly connected via at least 2 or more (3, 4, 5, 6, etc.) grid hinges, said grid hinges comprising one or more loops, wherein said loops embrace the most proximate grid rod of each the adjoining grid sections.

Preferably, at least one, and preferably all, of the grid hinge comprises at least one loop which embraces the most proximate grid rods of each of the adjoining grid sections. Preferably, the (opening of the) loops are kept compact, to allow minimal movement between the two grid rods extending therethrough, while still allowing rotation with respect to each other.

Preferably, at least one, and preferably all, of the grid hinge comprises two or more loops, of which a first embraces the most proximate grid rod of one of the adjoining grid sections, and of which a second embraces the most proximate grid rod of the other of the adjoining grid sections, said loops being attached to each other. Again, preferably the (openings of the) loops are kept compact to allow minimal movement between the two grid rods extending therethrough, while still allowing rotation with respect to each other.

Note that a mix of the two above options is also possible, with some grid hinges having a single loop, and others having more than one.

In a further preferred embodiment, the grid hinges connecting the first and second grid sections to the central grid sections comprise at least one loop which embraces the most proximate grid rods of each of the adjoining grid sections, and wherein the grid hinges connecting the central grid sections comprise two or more loops, of which a first embraces the most proximate grid rod of one of the adjoining grid sections, and of which a second embraces the most proximate grid rod of the other of the adjoining grid sections, said loops being attached to each other.

In an even further preferred embodiment, the grid comprises two central grid sections, said two central grid sections being hingedly connected by at least two, preferably three, grid hinges comprising two or more loops, of which a first embraces the most proximate grid rod of one of the central grid sections, and of which a second embraces the most proximate grid rod of the other of the central grid sections, said loops being attached to each other via a connector; preferably wherein said grid hinges comprising two or more loops are mutually connected by an intermediate frame, keeping the first of the loops of each grid hinge aligned, and keeping the second of the loops of each grid hinge aligned. The attachment of the loops via the connector allows the central grid sections to be held hingedly connect, while maintaining a distance between the two central grid sections. This can be even more effectively be achieved by providing an intermediate frame between the two central grid sections, which acts as a strengthening for the grid hinges therebetween.

In a preferred embodiment, at least three grid hinges are provided at each hinge side, said grid hinges being separated from each other by at least two support rods between every grid hinge, said support rods furthermore limiting lateral movement of the grid hinges to a subsection of at most 10% of the grid rod it embraces. Proper spacing between the grid hinges ensures the reliability of the unfolded grid. By keeping the grid hinges within certain zones over which they can move laterally, they are kept loose enough to allow movement of the grid sections, but sufficiently in place to ensure a good support.

In an alternative embodiment, the grid comprises at least 3 central grid sections, wherein said central grid sections comprise at least two outer central grid sections and at least one middle central grid section, said middle central grid section being positioned between the outer central grid sections and hingedly connected with at least one, preferably two, outer central grid sections. Said middle central grid section comprising a rectangular intermediate frame of interconnected grid rods parallel to the hinge sides of the middle central grid section, and comprising at least two grid hinges at each hinge side, fixedly or hingedly attached to the rectangular intermediate frame of the middle central grid section, wherein said grid hinges are hingedly connected to the outer central grid section, preferably said grid hinges comprising a loop or partial loop through which the most proximate grid rod of the adjoining outer central grid section extends. Preferably, said middle central grid section has a maximal width of 5.0 cm, more preferably at most 4.0 cm.

Preferably, the middle central grid section comprises alignment elements extending on both hinge sides thereof, said alignment elements being rigidly affixed to the frame of the middle central grid section.

In a preferred embodiment, the grid comprises at least 2 central grid sections, wherein said central grid sections are connected to a rectangular intermediate frame, comprising two opposite and parallel hinge sides adjoining the hinge sides of the central grid sections, said hinge sides of the intermediate frame each comprising at least at least two central grid hinges, fixedly or hingedly attached to the rectangular intermediate frame, wherein said central grid hinges are hingedly connected to the adjoining hinge sides of the central grid sections, preferably said central grid hinges comprising a loop or partial loop through which the most proximate grid rod of the adjoining outer central grid section extends. The central grid hinges can be fixedly attached as an extension of the intermediate frame, or hingedly attached, for instance by comprising one or more loops which embrace the hinge side of the adjoining central grid section and/or a hinge side of the intermediate frame (which hinge side can be in the form of a rod parallel to the hinge side, similar to that of the grid sections).

The intermediate frame preferably comprises two rods extending parallel to the adjoining hinge sides, which are connected by two (or more) connection rods towards the ends of the two rods. The grid hinges on the intermediate frame are connected (fixedly or hingedly) to said two rods. The width (distance between the two rods) is limited, for instance at most 5.0 cm, 4.0 cm, 3.0 cm or less, as this dictates the thickness of the folded grid. The width is preferably at least 0.5 cm or 1.0 cm, as the outermost grid sections are folded inwards, and are positioned between the two mutually parallel central grid sections when folded.

Note that the distinction between the middle central grid section and the intermediate frame in some embodiments is merely linguistic. The middle central grid section is in some embodiments very narrow, thereby potentially not being seen as a grid section, and more as an intermediate frame to keep the adjoining (central) grid sections separate. It should be understood that the description and claims are to be read with this in mind.

In a preferred embodiment, the intermediate frame is provided with a mounting means. The foldable grid comprises a removable elevated grid platform, said grid platform mountable on the mounting means. Preferably, the mounted grid platform is substantially parallel to the intermediate frame, and more preferably positioned at least 5.0 cm above said intermediate frame. The grid platform can be mounted on the mounting means via a connector (pin). The desired elevation can be easily accomplished by suitably modifying the mounting means and/or connector.

In a preferred embodiment, the support rods of adjoining grid sections are positioned shifted along the length of the grid rods over at most 1.0 cm, preferably at most 0.5 cm, and whereby the support rods are positioned essentially symmetrically with respect to the perpendicular plane passing through the middle of the grid rods. More preferably, they are shifted over at most 0.25 mm, and are most preferably shifted over a distance substantially equal to the diameter of the support rods, thereby, upon unfolding, having the support rods directly adjacent to each other.

In a preferred embodiment, the support rods are angled between 30° and 60° with respect to the grid rods, and preferably symmetrically positioned in view of the perpendicular plane passing through the middle of the grid rods.

In a preferred embodiment, the grid sections comprise an outer rod on the sides that are not hinge sides, said outer rods of the grid sections defining a closed loop around the grid when unfolded. Said outer rod or rods combine to form the closed loop around the unfolded grid, and can be shaped to form a rectangle, square, oval, circle, etc.

In some embodiments, no central pivoting supporting means is present, and each hinge connection between grid sections comprises alignment means on at least one hinge side at said hinge connection. The alignment means extend to limit the rotation of the grid sections with respect to each other to a maximal angle of 180°. In some embodiments, a central pivoting supporting means is present, but serves only to support a selection of the grid sections (the innermost), while the alignment means support the other grid sections. Alignment means may still be provided to support the innermost grid sections in concert with the central pivoting supporting means. In some embodiments, the central pivoting supporting means supports all grid sections. However, alignment means may still be provided to additionally support some or all grid sections, for instance the innermost who are subject to more weight of the outer grid sections.

The support rods can extend perpendicular to the grid rods, but can also extend under a different angle, such as about 45°, or between 30° and 60°. A mix of both can also be used, with some support rods extending under a first angle (for instance) 90°, and other under a second, or even third, fourth, etc. angle (such as 45°).

In a second aspect, the invention relates to a grid assembly comprising a number of detachable substantially planar grid sections. The assembly comprises at least a first grid section, a second grid section and one or more central grid sections positioned between the first and the second grid section, wherein the central grid sections comprise two opposite and parallel connection sides, and wherein the first and the second grid section each comprise one connection side, parallel to and adjoining the connection side of an adjacent central grid section.

The grill sections comprise a plurality of parallel (and preferably mutually equidistant) grid rods, which are interconnected by one or more support rods, wherein the support rods are preferably positioned at the same side of the grid section. The grid rods of the central grid sections are parallel with the connection sides of the central grid sections, and wherein the grid rods of the first and second grid sections are parallel with the connection side of the first and second grid sections.

In a first version of the second aspect, at least one grid section of every two adjoining grid sections comprises two or more connection rods with connector elements or jamming means on each connection side, said connector elements or jamming means being adapted to receive the grid rods of the other grid section of the two adjoining grid sections, said connection rods extending at the bottom of the grid section from the connection sides and being parallel to the plane of the grid section, wherein said connector elements or jamming means face upwards to receive the adjoining grid section from below the adjoining grid section.

In a possible embodiment, jamming means of each connection side are distanced from said connection side over at least two different distances, said two different distances differing with an integer number of times the distance between two subsequent grid rods.

Preferably, the connection rods are incorporated into the support rods.

In a preferred embodiment, the connection rods of adjoining connection sides of two adjoining grid sections are positioned to, when connected, extend directly next to each other.

In a preferred embodiment, the connection rods of a connection side of each grid section are laterally shifted with respect to the connection rods of the adjoining connection side of an adjoining grid section, over a distance substantially equal to the diameter of the connection rods.

In a preferred embodiment, at least one of the connection rods of a connection side of each grid section is laterally shifted with respect to the connection rods of the adjoining connection side of an adjoining grid section to a first lateral direction, and at least one of the connection rods of a connection side of each grid section is laterally shifted with respect to the connection rods of the adjoining connection side of an adjoining grid section to a second lateral direction different than the first lateral direction.

In a preferred embodiment, the jamming means comprise a C-shaped holding element, preferably opening upwards (but alternatively downwards). The holding element is shaped to accommodate a grid rod therein, and can be further adapted to clamp it.

In a preferred embodiment, at least one of two adjoining grid sections comprises a connection rod without a (complete) jamming means. The other of the two adjoining grid sections comprises a loop positioned to receive the connection rod therethrough. The combination of this connection rod without the (complete) jamming means with one or more connections rod with a jamming means that receives a grid rod of the adjoining grid section in a way that limits movement away from each other (for instance by embracing the grid rod from above or below, such as with the C-shaped holding element) is especially useful. The connection rod with the jamming means allows the grid sections to be connected where the grid sections cannot move away from each other when coupled. The connection rod without the (complete) jamming means forms a first connection with the loop of the other grid section, ensuring that the grid sections cannot rotate or tilt with respect to each other. The connection rod without the complete jamming means can be provided with a stopper (for instance in the form of a thicker section or lateral extension), to limit its introduction into the loop past a certain point.

In a second version of the second aspect, the grid sections are connectable via one or more support means. Each of the grid sections comprises one or more pairs of hook elements extending from below the grid section and directed towards each other. The paired hook elements are distanced equally on each grid section, with a minimal opening equal to the distance between the distal ends of the hook elements, and a maximal opening equal to the distance between the attachment point of the hook elements to the grid section. The support means are substantially rectangularly shaped (although variations can exist which likewise effect the positioning of the hook elements), with two longitudinal rods connected at the ends (at least) by a transverse rod. The longitudinal rods are separated by a distance larger than the minimal opening distance. The support means allow some flexing of the longitudinal rods towards each other (elastically deforming), to allow passage between the distal ends of the hook elements, and thereafter revert to their original distance, fitting into the hook elements. The longitudinal rods, when not under influence of external forces, can be separated by a distance larger than the maximal opening of the hook elements thereby ensuring they clamp the grid sections when ‘unflexing’ into the hook elements.

Preferably, at least two support means are provided, with each grid section comprising at least two pairs of hook elements (one for each support means), which are evenly spaced out across the grid rods, to ensure balance and structural integrity. In a further adaptation, two pairs of hook elements can be provided for each support means on each grid section, to increase stability.

Preferably, the support means comprises a spacer on each longitudinal end thereof, extending perpendicularly with respect to the plane defined by the longitudinal rods. This spacer allows the support means to hook itself behind a grid rod of the outermost grid sections, ensuring that the grid sections cannot move or slide along the longitudinal rods.

In some embodiments, handles are provided which can be removably attached to the support means and/or to the grid sections.

In some embodiments, handles can be hinged to the support means and/or to the grid sections.

In all aspects and version of the invention, the grid assembly can be provided with removable handles, which can be coupled to matching receiving elements therefor on the grid sections. These can be a number of loops, through which an elongate section of the handle extends, but can also be clamps or other connection techniques.

### DESCRIPTION OF THE FIGURES

FIG. 1 is a perspective view of the combination of the store box and folded grid.

FIG. 2 is a perspective view of an assembled grid according to preferred embodiment one.

FIG. 3 is perspective exploded view of an assembled grid according to preferred embodiment one.

FIG. 4 is a perspective view of an assembled grid according to preferred embodiment two.

FIG. 5 is perspective exploded view of an assembled grid according to preferred embodiment two.

FIG. 6 is the perspective view of an assembled grid according to preferred embodiment three.

FIG. 7 is a perspective view of a folded grid according to preferred embodiment three.

FIG. 8 is a perspective view of a semi folded grid according to preferred embodiment three.

FIG. 9 is a perspective view of an assembled grid according to preferred embodiment four.

FIG. 10 is perspective exploded view of an assembled grid according to preferred embodiment four.

FIG. 11 is a perspective exploded view of a semi folded grid according to preferred embodiment four.

FIG. 12 is a perspective view of a semi folded grid according to preferred embodiment four.

FIG. 13 is a perspective view of a folded grid according to preferred embodiment four.

FIG. 14 is a perspective view of an assembled grid according to preferred embodiment five.

FIG. 15 is a perspective view of a partly folded grid according to preferred embodiment five.

FIG. 16 is a perspective view of an assembled grid according to preferred embodiment five.

FIG. 17 is a detailed perspective view according to preferred embodiment five.

### DESCRIPTION OF THE DIFFERENT PARTS

1. Box: to store the grid. This box can contain water and an additive to clean the grid. To support the active effect of the product, the water can be heated using a heating element.
2. Pump: the most active components are in the form of a powder. This powder has to be mixed actively. One way to achieve this is to use a pomp to rotate the water so that the powder mixes faster and better with the water.
3. Input: this is the input of the pump
4. Output: this is the output of the pump
5. Heating element: the is the heating element in the box to heat the water in the box.
6. Grid: this is the total grid
7. Grid part 1 or first grid section
8. Grid part 2 or (outer) central grid section
9. Grid part 3 or (middle) central grid section
10. Grid part 4 or (outer) central grid section
11. Grid part 5 or second grid section
12. Outer rod: this is the supporting rod on the outside of the grid.
13. Grid hinge: this hinge connects different grid parts and makes it possible that they can rotate relative to each other.
14. Gripping pliers: these pliers allow to handle the grid when it is still warm. In some cases, it also can be used to grasp the food.
15. Handle: this part can be attached directly to the grid or be a part of the gripping pliers
16. Gripper arms: this is the part of the gripping pliers that grabs the grid or the food itself.
17. Support rod: these rods are aligning the different grid parts when they are mounted.
18. Mounting piece: in some embodiments, the support means must be jammed when mounted. The mounting pieces are providing the tool to jam the supporting means.
19. Mounting means: in some embodiments, an extra grid is located above the grid. This mounting means, preferably in the form of a pin provides support for the elevated grid platform, preferably via a connector pin.
20. Connector pin: this pin connects the grid and the elevated grid platform.
21. Central supporting means: this rod supports the folded grid.
22. Blocking means: these blocking means blocks the central pivoting supporting rods in an unfolded position.
23. Swivel joint: the joins connect the central supporting means and the central pivoting supporting means.
24. Support means, intermediate frame or middle central grid section: to support and block the joined grid parts.
25. Central pivoting supporting means: this rod supports the unfolded grid.
26. Elevated grid platform: this grid plate can be added on top of the connector pin.
27. Additional pins: in some embodiments, pins are added to hang the grid in the barbecue.
28. Connector: this connects the connector pin with the elevated grid platform
29. Grid rod support: this supports the rods of the grid itself.
30. Grid rods: these are the rods of the grid.
31. Upright clamping part/spacer: this part of the supporting means clamps the different grid parts together.
32. Jamming means: the connecting grid parts are being jammed using the jamming parts. These are blocking the grid part by jamming the grid rod of the connecting grid part.
33. Connection sides: the sides at which the separate grid sections can be connected to each other
34. Alignment elements: elements extending from the grid sections to limit the pivoting of the grid sections to an angle of 180° with respect to each other
35. Hinge sides: the sides at which the separate grid sections are hingedly connected to each other, or to the intermediate frame
36. (C-shaped) holding element: element for receiving and supporting grid rod of adjoining grid section
37. a) connection rod with jamming means: extension on grid section to couple to adjoining grid section
37. b) connection rod without (complete) jamming means: extension on grid section to couple to adjoining grid section
38. loop for receiving connection rod without (complete) jamming means

### DETAILED DESCRIPTION OF PREFERRED EMBODIMENTS

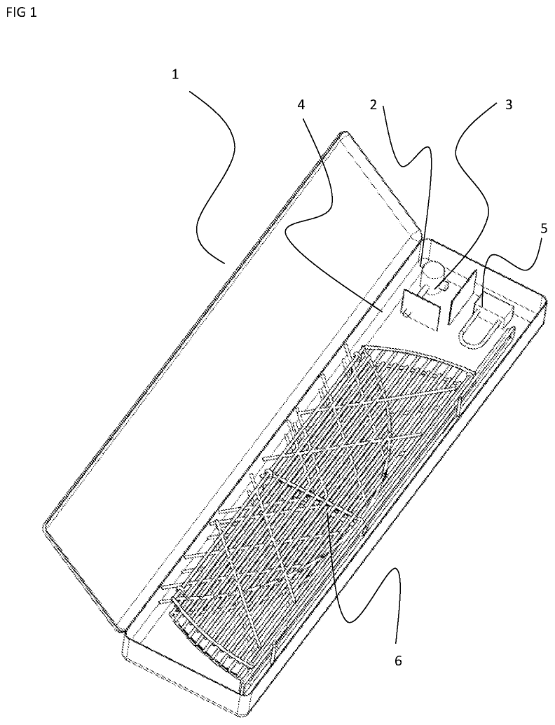

FIG. 1 is a perspective view of the combination of storage box 1 and folded grid.

The goal of the invention is to store grid 6 in box 1 so that the cleaning products can do their work in optimal conditions and that it is still manageable for the user. A pump 2 is provided in box 1, making it possible to mix the cleaning product with a liquid such as water. One possible embodiment is that input 3 of the pump 2 sucks up the cleaning product together with part of the liquid and pushes the mixture around in box 1 via output 4.

In the box 1, around pump 2, extra space can be provided where the cleaning product can be placed.

Most cleaning products work optimally if they are heated to a certain temperature and can maintain this temperature for a certain period. A heating element 5 can also be provided for this purpose, optionally supplemented with a timer, which can heat up the temperature of the liquid in the box 1 to the desired temperature. In FIG. 1, an arrangement is provided with a folded grid 6, but this could just as well be a grid 6, the pieces of which are arranged separately on top of each other in the box 1.

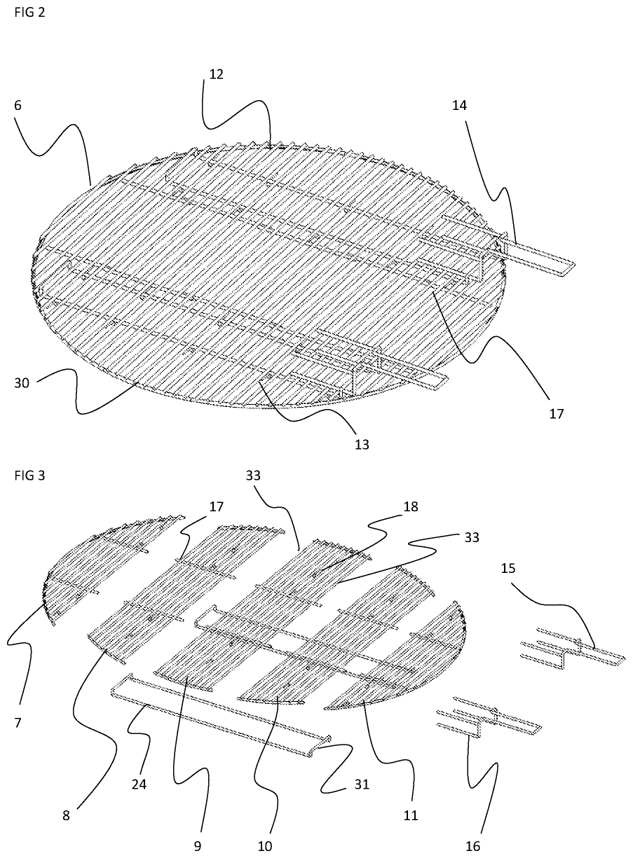

FIGS. 2 and 3 show views of a grid according to preferred embodiment one.

In this embodiment, a grid 6 is described which is round in shape and where the grid rods 30 are supported by the outer rod 12 in combination with the support rod 17. In this embodiment, the grid 6 is divided into five parts, grid part 1 7, grid part 2 8, grid part 3 9, grid part 4 10, and grid part 5 11. Grid part 3 9 is in this case the central part. Each grid part is equipped with the support rods 17. Its purpose is to position the grid parts correctly concerning each other, but also, to support each other, which can be complemented by extension on the grid section or of the support rods 17 in the form of alignment elements 34 which extend from the hinge sides 35 to a position under adjoining grid sections. Where the different grid parts touch, the support rods 17 are sticking out. As a result, they come under the grid rods 30 of the other grid part to support the adjacent grid part. The support rods 17 are positioned in such a way that they come to lie next to each other when the various grid parts are mounted so that the grid 6 acquires its round shape. When composing the grid 6, the different parts are combined, whereby grid part 1 7 is connected with grid part 2 8, grid part 2 8 is connected with grid part 3 9, grid part 3 9 is connected with grid part 4 10, and grid part 4 10 is connected with grid part 5 11.

The various parts are held together by the support means 24. After mounting the various grill parts, the support means 24 is clicked onto the grid 6. An upright clamping part or spacer 31 is provided at the end of the support means 24, which presses the various grid parts against each other. To connect the support means 24 per grate part. Each grate part is equipped with mounting piece 18. These mounting piece 18 clamps the support means 24. To be able to remove the grid 6 from the barbecue, this version is provided with detachable gripping pliers 14. These gripping pliers 14 are made up of handle 15 and gripper arms 16. The gripper arms 16 are provided with several legs so that these gripping pliers 14 can also be used as gripping tongs to grip the food.

In this embodiment, the support means 24 is a separate element from the grid 6. In other embodiments, the support means 24 can remain fixedly attached to at least one grid portion.

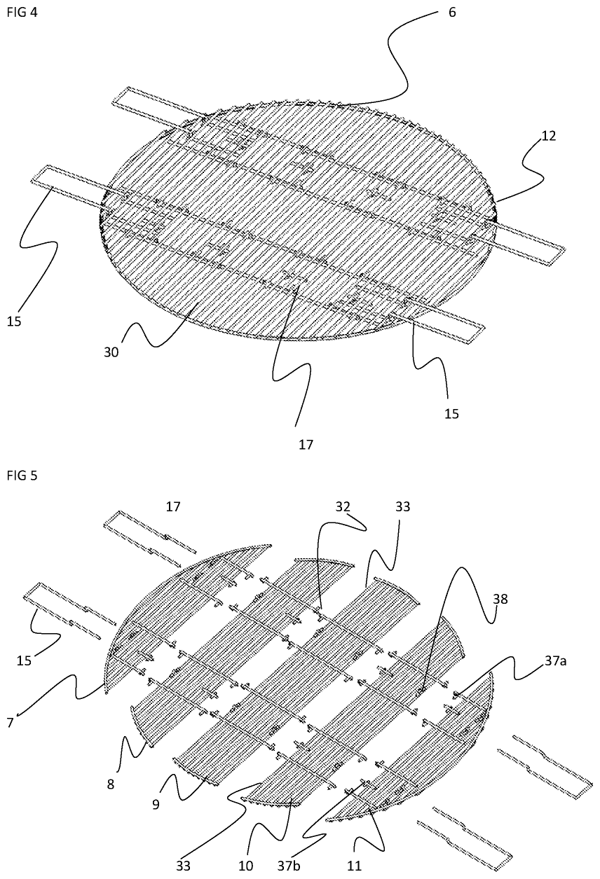

FIGS. 4 and 5 show views of a grid according to preferred embodiment two.

In this embodiment, a grid 6 is described which is round in shape and where the grid rods 30 are supported by the outer rod 12 in combination with the support rod 17. In this embodiment the grid 6 is divided into five parts grid part 1 7, grid part 2 8, grid part 3 9, grid part 4 10, and grid part 5 11. Grid part 3 9 is in this case the central part. Each grid part is equipped with the support rods 17. Its purpose is to position the grid parts correctly concerning each other, but also to support each other. Where the different grid parts touch, the support rods 17 stick out. As a result, they extend under the grid rods 30 of the other grid part to support the adjacent grid part. The support rods 17 are positioned so that they come to lie next to each other when the various grid parts are mounted so that the grid 6 acquires its round (or other) shape. When composing the grid 6, the different parts are combined, whereby grid part 1 7 is connected with grid part 2 8, grid part 2 8 is connected with grid part 3 9, grid part 3 9 is connected with grid part 4 10, and grid part 4 10 is connected with grid part 5 11.

The different parts are held together by the jamming means 32, which are positioned on a connection rod 37a extending from the connection sides 33, and furthermore by connection rods without (complete) jamming means 37b, which can slide into a loop 38 on the adjoining grid section. The assembly of the different grid parts is obtained by moving the different grid parts towards each other at a certain angle and aligning the grid parts when connecting. Jamming means 32 are provided at the end of the support rod 17, which blocks the connecting grid parts concerning each other. The jamming means comprises a C-shaped holding element 36. To remove the grid 6 from the barbecue, this version is equipped with a detachable handle 15.

In this embodiment, the support means 24 is a separate element from the grid 6. In other embodiments, the support means 24 can remain fixedly attached to at least one grid portion.

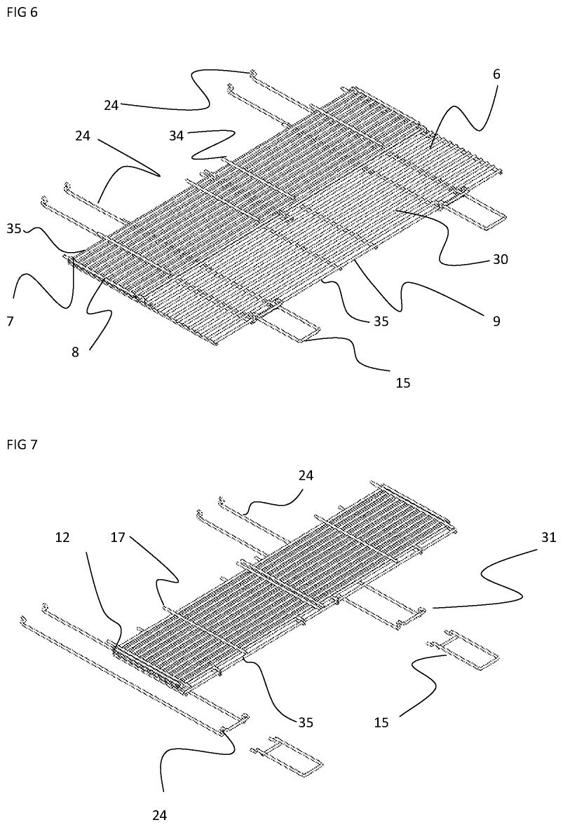

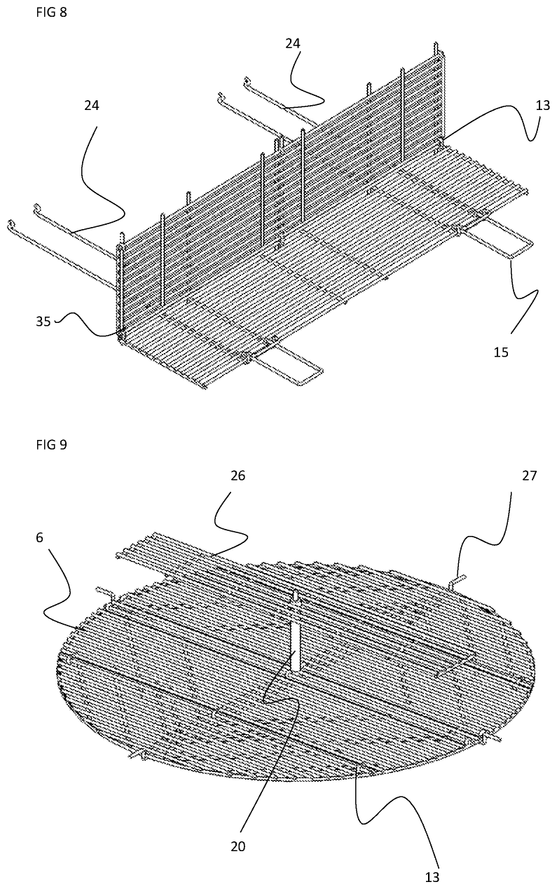

FIGS. 6, 7, and 8 show views of a grid according to preferred embodiment three.

In this embodiment, a grid 6 is described which is rectangular and wherein the grid rods 30 are supported by the outer rods 12 in combination with the support rods 17. In this embodiment, the grid 6 is divided into three parts grid part 1 7, grid part 2 8, and grid part 3 9 and these grid parts are arranged foldable concerning each other. Here grid part 2 8 forms the central part. The adjacent grids are herein provided with grid hinges 13, which makes the different grid parts foldable concerning each other.

Each grid part is equipped with support rod 17. Its purpose is to position the grid parts correctly concerning each other. But also, to support each other. Where the different grid parts touch, the support rod 17 stick out. As a result, they come under 30 of the adjacent grid parts to support the adjacent grid part. The support rod 17 are positioned so that they come to lie next to each other when the various grid parts are unfolded so that the grid 6 acquires its rectangular shape. When expanding the grid 6, the different parts are merged, whereby grid part 1 7 is connected with grid part 2 8 and grid part 2 8 is connected with grid part 3 9.

The different parts are held together by the support means 24. After folding out the different grid parts, the support means 24 is clicked on the 6. An upright clamping part or spacer 31 is provided at the end of the support means 24, which presses the various grid parts against each other. To be able to remove the 6 from the barbecue, this embodiment is provided with a detachable handle 15. In this embodiment, the handle 15 is connected to the support means 24.

In this embodiment, the support means 24 is a separate element from the grid 6. In other embodiments, the support means 24 can remain fixedly attached to at least one grid portion.

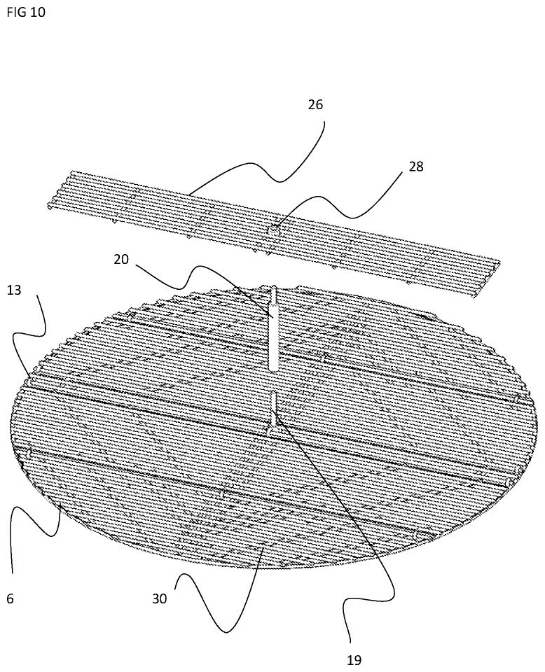

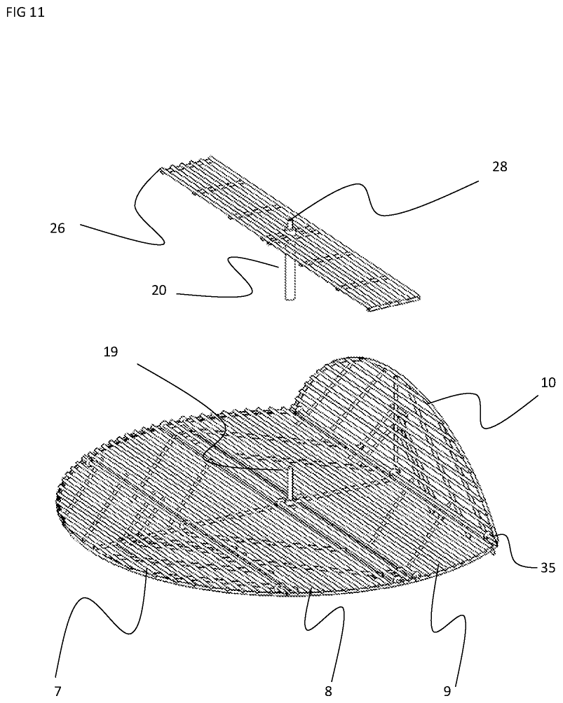

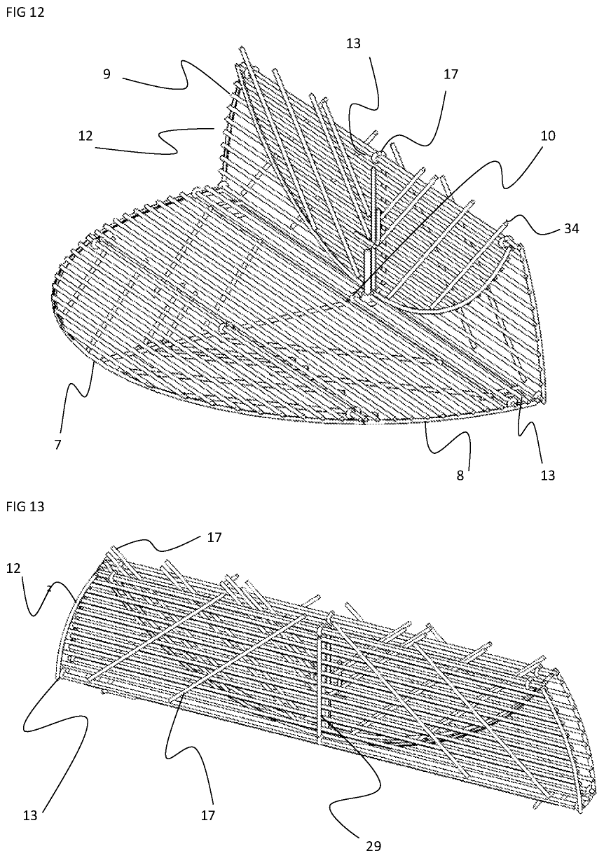

FIGS. 9, 10, 11, 12 and 13 showing views of a grid according to preferred embodiment four.

In this embodiment, a grid 6 is described, which is round and where the 30 are supported by the outer rod 12 in combination with the support rod 17. In this embodiment, the 6 is divided into four parts grid part 1 7, grid part 2 8, grid part 3 9, and grid part 4 10. The adjacent grids are herein provided with grid hinge 13, which makes the different grid parts foldable concerning each other.

Each grid part is equipped with support rod 17. The purpose of this grid is to support the grid parts. Where the different grid parts touch, the support rods 17 are sticking out. As a result, they come under the grid rods 30 of the other grid parts to support the adjacent grid part. When the grid 6 is unfolded, the different grid parts are aligned, whereby grid part 1 7 relates to grid part 2 8, grid part 2 8 is connected with grid part 3 9, and grid part 3 9 is connected with grid part 4 10.

Preferably, a detachable connector pin 20 is provided on the central portion. It can be mounted on pin 19. On connector pin 20, the elevated grid platform 26 can be applied via connector 28. The different grill parts can be folded together to fit in the 1.

To be able to remove the 6 from the barbecue, this version can also be equipped with detachable gripping pliers 14.

The grid 6 can also be equipped with (detachable) additional pins.

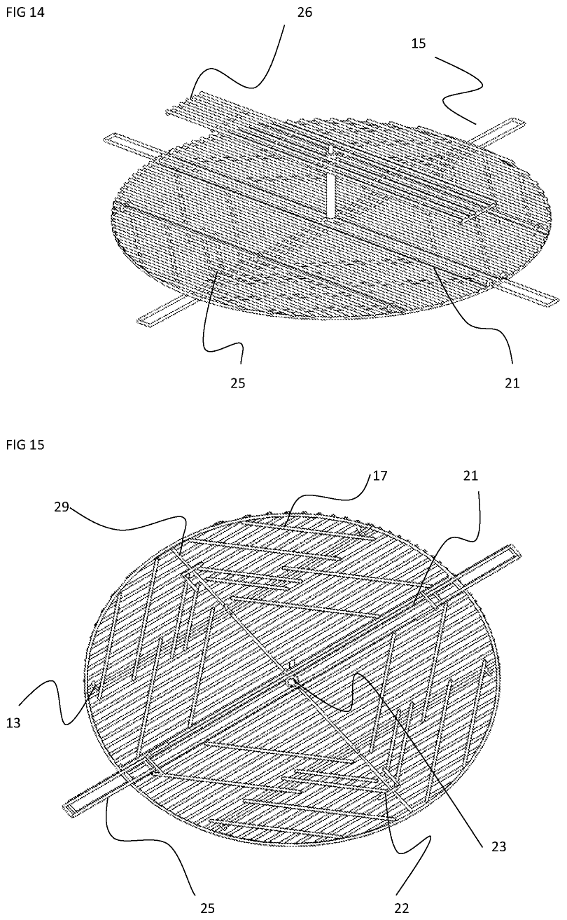

FIGS. 14, 15, 16, and 17 show views of a grid according to preferred embodiment five

This embodiment is a variant of the previous embodiment in which a central supporting means 21 is provided, which is provided with a swivel joint 23 connecting the central supporting means 21 to the central pivoting supporting means 25. In the folded state, the central pivoting supporting means 25 lies in the same direction as central supporting means 21. In the unfolded state, the central supporting means 21 are arranged at 90° concerning the central pivoting supporting means 25. central pivoting supporting means 25 supports the partial grids.

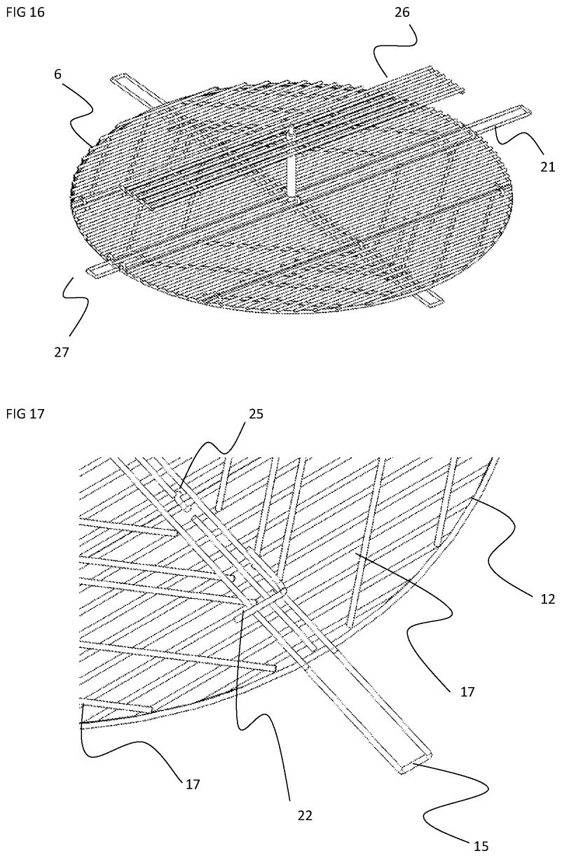

Both central supporting means 21 and central pivoting supporting means 25 can be provided with handle 15 and/or additional pins. In FIG. 14, both sides of central supporting means 21 and central pivoting supporting means 25 are provided with handle 15 so that the grate can easily be placed on the barbecue. In this embodiment, these are straight in shape, but they can also be of a pleated design so that the grid 6 can also be set up recessed in a barbecue if necessary. In FIG. 16, the central supporting means 21 and central pivoting supporting means 25 are provided with handle 15 on one side and with additional pins 27 on the other side, so that the additional pins 27 can be considered as ankle support.

When unfolded, central pivoting supporting means 25 are clamped by blocking means 22 so that it remains in place during the use of the grid 6.

1. Foldable grill grid, subdivided in substantially planar, subsequent grid sections, the grid comprising at least a first grid section, a second grid section and one or more central grid sections positioned between the first and the second grid section, wherein the central grid sections comprise two opposite and parallel hinge sides, and wherein the first and the second grid section each comprise one hinge side, parallel to and adjoining the hinge side of an adjacent central grid section;
wherein the grid sections comprise a plurality of parallel and mutually equidistant grid rods, which are interconnected by one or more support rods, wherein the support rods are positioned at the same side of the unfolded grid;
wherein the first grid section is hingedly connected with one hinge side to one of the hinge sides of one of the central grid sections, wherein the second grid section is hingedly connected with one hinge side to one of the hinge sides of one of the central grid sections, and wherein each central grid section is hingedly connected with each of its hinge sides to a hinge side of at least one of the grid sections;
wherein the grid rods of the central grid sections are parallel with the hinge sides of the central grid sections, and wherein the grid rods of the first and second grid sections are parallel with the hinge side of the first and second grid sections;
wherein at least one of the first grid section or the adjoining central grid section comprise at least one, alignment elements, which extends beyond the at least one grid section and parallel thereto past the hinge side of the at least one grid section adjoining the hinge side of the other grid section, thereby limiting the hinging of the two adjoining grid sections to an angle of about 180° in at least one direction of rotation;
wherein at least one of the second grid section or the adjoining central grid section comprise at least one, alignment elements, which extends beyond the at least one grid section and parallel thereto past the hinge side of the at least one grid section adjoining the hinge side of the other grid section, thereby limiting the hinging of the two adjoining grid sections to an angle of about 180° in at least one direction of rotation.

2. The foldable grid according to claim 1, wherein the grid comprises a central pivoting supporting means, extending over a length at least higher than the distance between the first and second section when the grid is unfolded, said central pivoting supporting means being attached to a central grid section to allow rotation around a rotation axis perpendicular to the plane of said central grid section, and having a width lower than the width of the central grid section to which it is rotatably attached.

3. The foldable grid according to claim 2, wherein at least one of the grid sections comprises a blocking means at a position on an axis perpendicular to the hinge side of the grid section and parallel to the unfolded grid, and said axis intersecting the rotation axis when the grid is unfolded, said blocking means being configured to limit rotation of the support section or central pivoting supporting means to an angle of about 90° with respect to the hinge sides of the grid sections, said blocking means being hook-shaped, with a distal end extending parallel to the grid rods.

4. The foldable according to claim 1, wherein the alignment elements are part of or extend from the support rods.

5. The foldable grid according to claim 1, wherein the alignment elements extend past the hinge side of the at least one of the grid sections over a distance at least greater than the distance between the hinge side of the other of the two adjoining grid sections and the closest grid rod thereof.

6. The foldable grid according to claim 1, wherein the hinge side of a first of two adjoining grid sections comprises a grid rod, and the hinge side of the second of the two subsequent grid sections comprises at least two grid hinges which are hingedly connected to the hinge side of the first of the two subsequent grid sections.

7. The foldable grid according to claim 1, wherein the adjoining grid sections are hingedly connected via at least 2 or more grid hinges, said grid hinges comprising one or more loops, wherein said loops embrace the most proximate grid rod of each the adjoining grid sections, preferably wherein:
at least one of the grid hinge comprises at least one loop which embraces the most proximate grid rods of each of the adjoining grid sections; and/or
wherein at least one of the grid hinge comprises two or more loops, of which a first embraces the most proximate grid rod of one of the adjoining grid sections, and of which a second embraces the most proximate grid rod of the other of the adjoining grid sections, said loops being attached to each other.

8. The foldable grid according to claim 7, wherein the grid hinges connecting the first and second grid sections to the central grid sections comprise at least one loop which embraces the most proximate grid rods of each of the adjoining grid sections, and wherein the grid hinges connecting the central grid sections comprise two or more loops, of which a first embraces the most proximate grid rod of one of the adjoining grid sections, and of which a second embraces the most proximate grid rod of the other of the adjoining grid sections, said loops being attached to each other.

9. The foldable grid according to claim 8, wherein the grid comprises two central grid sections, said two central grid sections being hingedly connected by at least two grid hinges comprising two or more loops, of which a first embraces the most proximate grid rod of one of the central grid sections, and of which a second embraces the most proximate grid rod of the other of the central grid sections, said loops being attached to each other; wherein said grid hinges comprising two or more loops are mutually connected by an intermediate frame, keeping the first of the loops of each grid hinge aligned, and keeping the second of the loops of each grid hinge aligned.

10. The foldable according to claim 7, wherein at least three grid hinges are provided at each hinge side, said grid hinges being separated from each other by at least two support rods between every grid hinge, said support rods furthermore limiting lateral movement of the grid hinges to a subsection of at most 10% of the grid rod it embraces.

11. The foldable grid according to claim 1, wherein the grid comprises at least 3 central grid sections, wherein said central grid sections comprise at least two outer central grid sections and at least one middle central grid section, said middle central grid section being positioned between the outer central grid sections and hingedly connected with at least one outer central grid sections;
said middle central grid section comprising a rectangular intermediate frame of interconnected grid rods parallel to the hinge sides of the middle central grid section, and comprising at least two grid hinges at each hinge side, fixedly or hingedly attached to the rectangular intermediate frame of the middle central grid section, wherein said grid hinges are hingedly connected to the outer central grid section, said grid hinges comprising a loop or partial loop through which the most proximate grid rod of the adjoining outer central grid section extends;
wherein said middle central grid section has a maximal width of 5.0 cm.

12. The foldable grid according to claim 11, wherein the middle central grid section comprises alignment elements extending on both hinge sides thereof, said alignment elements being rigidly affixed to the frame of the middle central grid section.

13. The foldable grid according to claim 1, wherein the grid comprises at least 2 central grid sections, wherein said central grid sections are connected to a rectangular intermediate frame, comprising two opposite and parallel hinge sides adjoining the hinge sides of the central grid sections, said hinge sides of the intermediate frame each comprising at least at least two central grid hinges, fixedly or hingedly attached to the rectangular intermediate frame, wherein said central grid hinges are hingedly connected to the adjoining hinge sides of the central grid sections, said central grid hinges comprising a loop or partial loop through which the most proximate grid rod of the adjoining outer central grid section extends.

14. The foldable grid according to claim 9, wherein the intermediate frame is provided with a mounting means, and wherein the foldable grid comprises a removable elevated grid platform, said grid platform mountable on the mounting means, whereby the mounted grid platform is substantially parallel to the intermediate frame, and positioned at least 5.0 cm above said intermediate frame.

15. The foldable grid according to claim 1, wherein the support rods of adjoining grid sections are positioned shifted along the length of the grid rods over at most 1.0 cm and whereby the support rods are positioned essentially symmetrically with respect to the perpendicular plane passing through the middle of the grid rods.

16. The foldable grid according to claim 1, wherein the support rods are angled between 30° and 60° with respect to the grid rods, and symmetrically positioned in view of the perpendicular plane passing through the middle of the grid rods.

17. The foldable grid according to claim 1, wherein the grid sections comprise an outer rod on the sides that are not hinge sides, said outer rods of the grid sections defining a closed loop around the grid when unfolded.
